(19) United States
(12) Patent Application Publication
(10) Pub. No.: US 2007/0152378 A1
(43) Pub. Date: Jul. 5, 2007

(54) Method of manufacturing nano-fibers with excellent fiber formation

(76) Inventor: Hak-Yong Kim, Jeonju-si (KR)

Correspondence Address: BIRCH STEWART KOLASCH & BIRCH, PO BOX 747, FALLS CHURCH, VA, 22040-0747, US

(21) Appl. No.: 10/584,411

(22) PCT Filed: Dec. 30, 2003
(86) PCT No.: PCT/KR03/02883

§ 371 Date: Jun. 26, 2006

(51) Int. Cl. H05B 7/00

(52) U.S. Cl. 264/465

(57) ABSTRACT

The present invention relates to a method for producing nanofibers with an excellent fiber formation property, characterized in that: when nanofibers 3 having a thickness of a nano level are produced by electrostatically spinning a spinning liquid 1 of a polymer resin solution on a collector 8 through a nozzle 2 under a high voltage, a collector 8 with a heater is used as the collector. The present invention can greatly improve the fiber formation property of the nanofibers.

### TECHNICAL FIELD

The present invention relates to a method for producing fibers having a thickness of a nano level (hereinafter, ‘nanofibers’), and more specifically to a method for producing nanofibers which is capable of effectively preventing nanofibers collected on a collector from being dissolved again by a remaining solvent, especially a solvent with a low volatility (a solvent with a high boiling point) to thus deteriorate fiber formation property by quickly volatilizing the solvent remaining on the collector using the collector with a heater.

More concretely, the present invention relates to a method capable of mass production of nanofibers at a high efficiency since remaining solvents can be volatilized more efficiently so that nanofibers electrostatically spun and collected on a collector are not dissolved again by the solvents remaining on the collector when nanofibers are produced by using a solvent with a low volatility (a solvent with a high boiling point) or nanofibers are electrostatically spun for a long time by using a solvent with a relatively high volatility (a solvent with a low boiling point) for the purpose of mass production.

### BACKGROUND ART

Products such as nonwoven fabrics, membranes, braids, etc. composed of nanofibers are widely used for daily necessaries and in agricultural, apparel and industrial applications, etc. Concretely, they are utilized in a wide variety of fields, including artificial leathers, artificial suede, sanitary pads, clothes, diapers, packaging materials, miscellaneous goods materials, a variety of filter materials, medical materials such as gene transfer elements, military materials such as bullet-proof vests, and the like.

A typical electrostatic spinning apparatus disclosed in U.S. Pat. No. 4,044,404 comprises a spinning liquid main tank for storing a spinning liquid; a metering pump for constant feeding the spinning liquid; a nozzle block with a plurality of nozzles arranged for discharging the spinning liquid; a collector located on the lower end of the nozzles and for collecting spun fibers; and voltage generators for generating a voltage.

An electrostatic spinning method utilizing the electrostatic spinning apparatus will be described in detail. A spinning liquid in the spinning liquid main tank is continuously constant-fed into the plurality of nozzles with a high voltage through the metering pump.

Continually, the spinning liquid fed into the nozzles is spun on the collector with a high voltage through the nozzles to collect the spun nanofibers on the collector.

In the case that nanofibers are produced by such typical electrostatic spinning method of the prior art, there is a problem that the nanofibers collected on the collector are dissolved by a solvent remaining on the collector to thereby greatly deteriorate the fiber formation ability.

Especially, in the case that a solvent with a low volatility (a solvent with a high boiling point) is used, the above-mentioned problem becomes more serious.

Further, even in the case that a solvent with a high volatility (a solvent with a low boiling point) is used, the above-mentioned problem occurs in a manner that, when nanofibers are electrostatically spun for a long time for the purpose of mass production, the solvent remains on the collector, and accordingly the nanofibers collected on the collector are dissolved.

As a result, the typical electrostatic spinning method of the prior art was not appropriate for mass production, and has limitations in the types of utilizable solvents.

### DISCLOSURE OF THE INVENTION

To solve the above problems, the present invention provides a method for producing nanofibers which is capable of effectively preventing nanofibers collected on a collector from being dissolved again by volatilizing the solvent remaining on the collector more quickly during an electrostatic spinning process.

Additionally, the present invention provides a method for mass production of nanofibers at higher fiber formation efficiency regardless of a solvent to be used.

To achieve the above objects, there is provided a method for producing nanofibers according to the present invention, characterized in that: when nanofibers 3 having a thickness of a nano level are produced by electrostatically spinning a spinning liquid 1 of a polymer resin solution on a collector 8 through a nozzle 2 under a high voltage, a collector 8 provided with a heater 6 is used as the collector 8.

Hereinafter, the present invention will be described in detail with reference to the accompanying drawings.

FIG. 1 is an enlarged schematic view of heater 6 and supporting element 7 sections of direct heating type in a collector employed in the present invention. FIG. 2 is an enlarged schematic view of heater 6 and supporting element 7 sections of indirect heating type in the collector employed in the present invention.

In the present invention, a collector 8 with a heater 6 of such a direct heating type as shown in FIG. 1 or a collector 8 with a heater 6 of an indirect heating type as shown in FIG. 2 is employed in order to promote the volatilization of the solvent remaining on the collector when electrostatically spinning nanofibers.

As an concrete example of the collector 8 with the heater 6 of direct heating type, can be used a laminate element of a three layer structure which is composed of (i) a supporting element 7 which is a lower end surface, (ii) a conductive plate 5 which is an upper end surface, and (iii) a heater 6 of direct heating type located between the supporting element and the conductive plate.

As the heater 6 of direct heating type, as shown in FIG. 1, can be used a heating plate 6a which has hot wires 6b covered with dielectric polymer arranged at constant intervals and a temperature controller 6c attached thereto.

As the dielectric polymer for covering the hot wires, preferably used is silicon having a superior current blocking property.

Silicon is advantageous in that it is easy to handle with because of a superior flexibility as well as the current flow blocking property.

The conductive plate 5 to be laminated on the top of the heater 6 is made from a material having a superior conductivity such as aluminum, copper, stainless steel, etc.

Meanwhile, the supporting element 7 located on a lower part of the heater 6 is preferably made from a dielectric material such as plastic or the like in order to minimize heat loss and increase adiabatic effect.

When the collector 8 with the heater 6 of direct heating type is used, heat is supplied to the hot wires 6b in the heater 6 during electrostatic spinning to heat the heating plate 6a, and the heat generated from the heating plate 6a is conducted to the conductive plate 5 forming the surface of the collector 8, to thereby quickly volatilize the solvent remaining on the collector 8.

Further, the surface temperature of the collector 8 can be controlled by the temperature controller 6c connected to the heating plate 6a.

On the other hand, as an concrete example of the collector 8 with the heater 6 of indirect heating type, can be used a laminate element of a three layer structure which is composed of (i) a supporting element 7 which is a lower end surface, (ii) a conductive plate 5 which is an upper end surface, and (iii) a heater 6 located between the supporting element and the conductive plate and indirectly heated by heat transfer medium circulation.

As the heater 6, as shown in FIG. 2, can be used a heater of such a plate type which has a heat transfer medium circulation tube 6e equipped inside and is connected to a circulation type heat reservoir 6d through a heat transfer medium feed section 6f and a heat transfer medium discharge section 6g.

As the heat transfer medium, can be used water, steam or oil. The present invention does not specifically limit the type of the heat transfer medium.

The conductive plate 5 laminated on the top of the heater 6 is made from a material having a superior conductivity such as aluminum, copper, stainless steel, etc.

Meanwhile, the supporting element 7 located on a lower part of the heater 6 is preferably made from a dielectric material such as plastic or the like in order to minimize heat loss and increase adiabatic effect.

When the collector 8 with the heater 6 of indirect heating type is used, the heater 6 is heated by circulating the heat transfer medium heated in the circulation type heat reservoir 6d into the heat transfer medium circulation tube 6e in the heater 6 during electrostatic spinning, and the heat generated from the heater 6 is conducted to the conductive plate 5 forming the surface of the collector 8, to thereby quickly volatilize the solvent remaining on the collector 8.

A mechanism of heating the heater 6 of indirect heating type will be described in more detail. As shown in FIG. 2, the heat transfer medium is heated at a desired temperature in the circulation type heat reservoir 6d. Next, the heated heat transfer medium is introduced into the heat transfer medium circulation tube 6e equipped in the heater 6 through the heat transfer medium feed section 6f, and then indirectly heats the heater 6 while flowing along the heat transfer medium circulation tube 6e. Next, the heat transfer medium whose temperature is lowered is circulated into the circulation type heat reservoir 6d through the heat transfer medium discharge section 6g and is heated again at a desired temperature. This circulation procedure is repeated.

The surface temperature of the collector 8 is properly controlled as needed. The temperature preferably ranges from a room temperature to 300° C., and more preferably from a room temperature to 200° C.

FIG. 3 is a process schematic view of the production of nanofibers in a top-down electrostatic spinning type by utilizing the collector 8 with the heater 6 according to the present invention. FIG. 4 is a process schematic view of the production of nanofibers in a down-top electrostatic spinning type by utilizing the collector 8 with the heater 6 according to the present invention. FIG. 5 is a process schematic view of the production of nanofibers in a horizontal electrostatic spinning type by utilizing the collector 8 with the heater 6 according to the present invention.

The collector 8 with the heater 6 of this invention is applicable regardless of angles of the nozzle and collector.

As a result, the present invention is applicable to all of the top-down electrostatic spinning, down-top electrostatic spinning and horizontal electrostatic spinning as shown in FIGS. 3 to 5.

As mentioned above, the present invention employs the collector 8 with the heater 6 of direct or indirect heating type, thus it can volatilize the solvent remaining on the collector 8 within a short time. Subsequently, it is possible to prevent the phenomenon that the nanofibers collected on the collector 8 are dissolved again by the remaining solvent, thereby improving fiber formation efficiency even in the case that a solvent with a low volatility (a solvent with a high boiling point) is used.

Additionally, the present invention is capable of mass production of nanofibers for a long time by using a solvent with a high volatility (a solvent with a low boiling point).

### BRIEF DESCRIPTION OF THE DRAWINGS

FIG. 1 is an enlarged schematic view of heater 6 and supporting element 7 sections of direct heating type in a collector 8 employed in the present invention;

FIG. 2 is an enlarged schematic view of heater 6 and supporting element 7 sections of indirect heating type in the collector 8 employed in the present invention;

FIG. 3 is a process schematic view of a top-down electrostatic spinning type according to the present invention;

FIG. 4 is a process schematic view of a down-top electrostatic spinning type according to the present invention;

FIG. 5 is a process schematic view of a horizontal electrostatic spinning type according to the present invention;

FIG. 6 is an enlarged photograph of a nanofiber web produced according to Example 1 (in which a heater of direct heating type is attached and used);

FIG. 7 is an enlarged photograph of a nanofiber web produced according to Example 2 (in which a heater of indirect heating type is attached and used); and

FIGS. 8 and 9 are enlarged photographs of a nanofiber web produced according to Comparative Example 1(in which no heater is used).

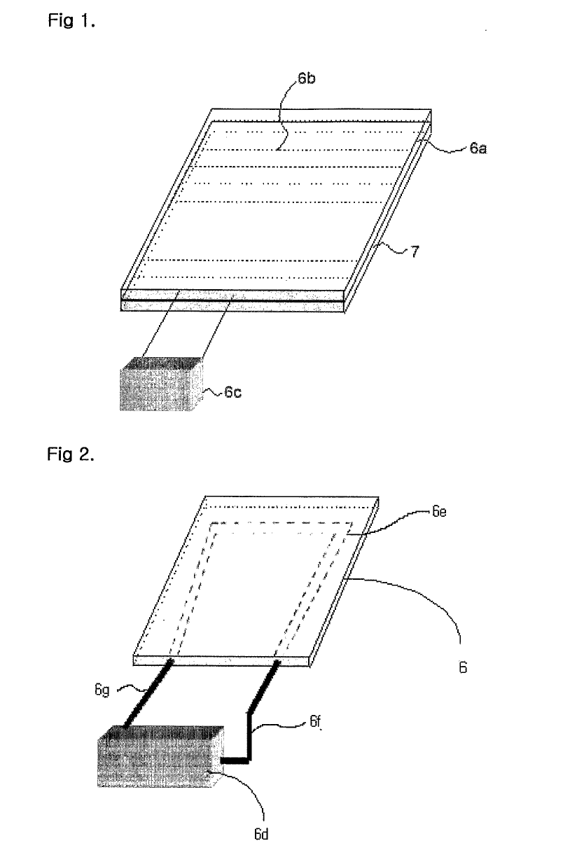

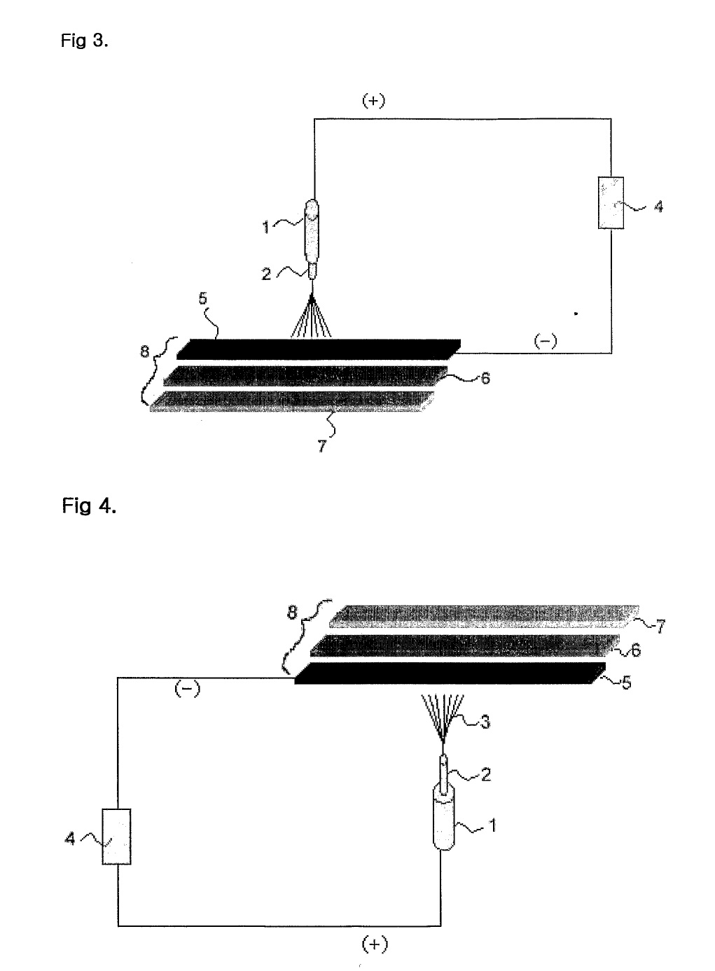

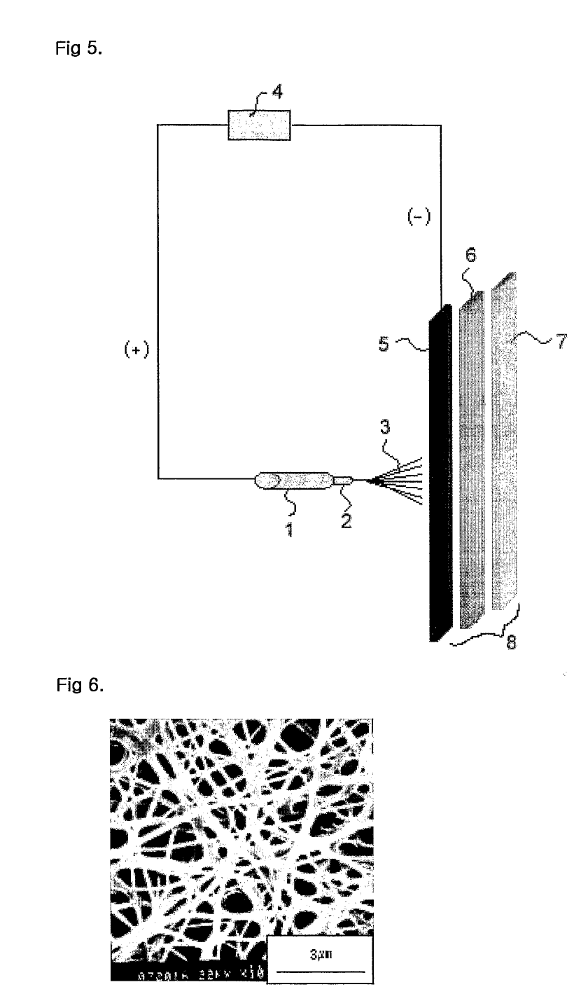

Explanation of Reference Numerals for the Main Parts of the Drawings.
1: spinning liquid which is a polymer resin solution 2: nozzle
3: electrostatically spun nanofiber 4: high voltage generator
5: conductive plate 6: heater
7: supporting element 8: collector (nanofiber accumulation plate)
6a: heating plate 6b: hot wire covered with dielectric polymer
6c: temperature controller 6d: circulation type heat reservoir
6e: heat transfer medium circulation tube 6f: heat transfer medium feed section
6g: heat transfer medium discharge section

### BEST MODE FOR CARRYING OUT THE INVENTION

The present invention is now understood more concretely by comparison between examples of the present invention and comparative examples. However, the present invention is not limited to such examples.

### EXAMPLE 1

8% by weight of polyurethane resin (Pellethane 2103-80AE of Dow Chemical Company) with a molecular weight of 80,000 was dissolved N, N-dimethylformamide to prepare a spinning liquid. Next, the prepared spinning liquid was electrostatically spun in a down-top electrostatic spinning method as shown in FIG. 4 to produce nanofibers.

During the electrostatic spinning, the voltage was 30 kV and the spinning distance was 20 cm. As a voltage generator, Model CH 50 of Simco Company was used. As a nozzle plate, a nozzle plate with 2,000 holes (nozzles) having a 0.8 diameter uniformly arranged was used.

Further, as a collector 8, was used a laminate element of a three layer structure which is composed of (i) a supporting element 7 of a polypropylene plate, (ii) a heater 6 of direct heating type located on the supporting element and composed of a heating plate 6a which has hot wires 6b covered with silicon arranged at constant intervals and a temperature controller 6c attached thereto, and (iii) a conductive plate 5 made from an aluminum film and located on top of the heater. The surface temperature of the collector was 95° C.

An enlarged photograph of a nanofiber web produced as above is as shown in FIG. 6.

### EXAMPLE 2

8% by weight of polyurethane resin (Pellethane 2103-80AE of Dow Chemical Company) with a molecular weight of 80,000 was dissolved N, N-dimethylformamide to prepare a spinning liquid. Next, the prepared spinning liquid was electrostatically spun in a down-top electrostatic spinning method as shown in FIG. 4 to produce nanofibers.

During the electrostatic spinning, the voltage was 30 kV and the spinning distance was 20 cm. As a voltage generator, Model CH 50 of Simco Company is used. As a nozzle plate, a nozzle plate with 2,000 holes (nozzles) having a 0.8 diameter uniformly arranged was used.

Further, as a collector 8, was used a laminate element of a three layer structure which is composed of (i) a supporting element 7 of a polypropylene plate, (ii) a heater 6 of such a plate type that has a heat transfer medium circulation tube 6e equipped inside and is connected to a circulation type heat reservoir 6d by a heat transfer medium feed section 6f and a heat transfer medium discharge section 6g, and (iii) a conductive plate 5 made from an aluminum film and located on top of the heater. The surface temperature of the collector was 85° C.

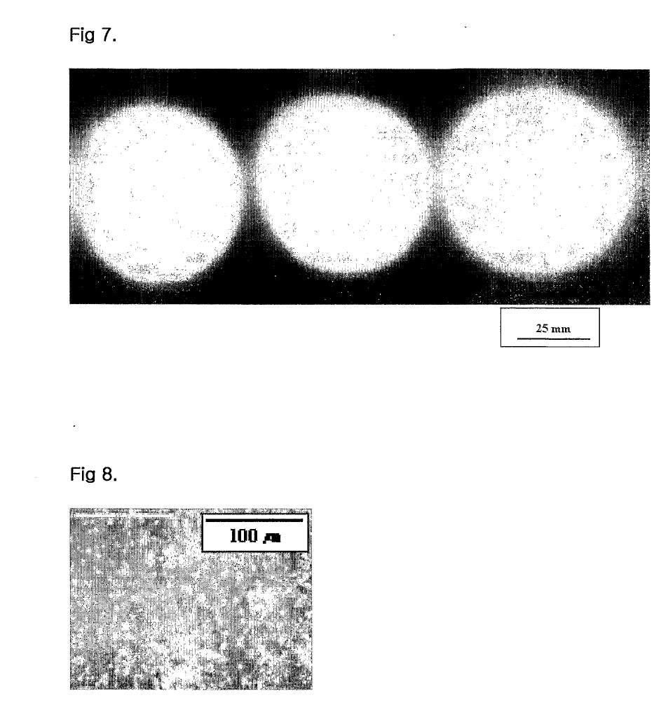

An enlarged photograph of the portion of a produced nanofiber web spun into three holes is as shown in FIG. 7.

### COMPARATIVE EXAMPLE 1

Nanofibers were produced in the same process and method as in Example 1 except that a typical collector with no heater 6 attached thereto was used in place of the collector 8 with a heater 6 of direct or indirect heating type of Example 1 or Example 2.

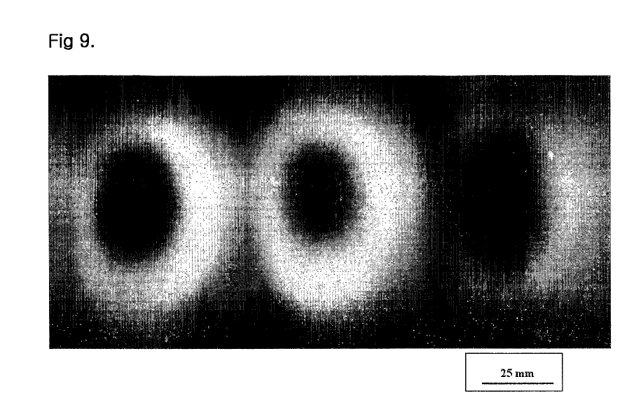

An enlarged photograph of a produced nanofiber web is as shown in FIG. 8, and an enlarged photograph of the portion of a produced nanofiber web spun into three holes is as shown in FIG. 9.

By comparison between FIG. 6, the enlarged photograph of the nanofiber web produced in Example 1 and FIG. 8, the enlarged photograph of the nanofiber web produced in Comparative Example 1, or by comparison between FIG. 7, the enlarged photograph of the nanofiber web produced in Example 2 and FIG. 9, the enlarged photograph of the nanofiber web produced in Comparative Example 1, it can be found out that the nanofibers produced in Example 1 and Example 2 maintain their fiber form as it is while the nanofibers produced in Comparative Example 1 are dissolved by the solvent on the collector and thus greatly damaged in their fiber form.

### INDUSTRIAL APPLICABILITY

The present invention can quickly volatilize the solvent remaining on the collector during an electrostatic spinning process and thus effectively prevent the nanofibers collected on the collector from being dissolved.

Accordingly, the present invention is capable of mass production of nanofibers regardless of the type of a solvent to be used and capable of greatly improving fiber formation efficiency.

What is claimed is:

1. A method for producing nanofibers with an excellent fiber formation property, characterized in that: when nanofibers 3 having a thickness of a nano level are produced by electrostatically spinning a spinning liquid 1 of a polymer resin solution on a collector 8 through a nozzle 2 under a high voltage, a collector 8 with a heater 6 is used as the collector 8.

2. The method of claim 1, wherein the collector with the heater 6 is a laminate element of a three layer structure which is composed of (i) a supporting element 7 which is a lower end surface, (ii) a conductive plate 5 which is an upper end surface, and (iii) a heater 6 of direct heating type located between the supporting element and the conductive plate.

3. The method of claim 1 or 2, wherein the heater 6 is a heating plate 6a which has hot wires 6b covered with dielectric polymer arranged at constant intervals and a temperature controller 6c attached thereto.

4. The method of claim 1, wherein the heater 6 is a heater indirectly heated by heat transfer medium circulation.

5. The method of claim 1, wherein the collector 8 with the heater 6 is a laminate element of a three layer structure which is composed of (i) a supporting element 7 which is a lower end surface, (ii) a conductive plate 5 which is an upper end surface, and (iii) a heater 6 located between the supporting element and the conductive plate and indirectly heated by heat transfer medium circulation.

6. The method of claim 4 or 5, wherein the heat transfer medium is water, steam or oil.

7. The method of claim 1 or 5, wherein the heater 6 is of such a plate type which has a heat transfer medium circulation tube 6e equipped inside and is connected to a circulation type heat reservoir 6d through a heat transfer medium feed section 6f and a heat transfer medium discharge section 6g.

8. The method of claim 2 or 5, wherein the conductive plate 5 is made from aluminum, copper or stainless steel.

9. The method of claim 2 or 5, wherein the supporting element 7 is made from plastic which is dielectric.

10. The method of claim 3, wherein the dielectric polymer is silicon.

11. The method of claim 1, wherein the electrostatic spinning method is a top-down electrostatic spinning type, a down-top electrostatic spinning type or a horizontal electrostatic spinning type.
